(19) United States
(12) Patent Application Publication
(10) Pub. No.: US 2022/0307300 A1
(43) Pub. Date: Sep. 29, 2022

(54) ELECTRICALLY ACTUATED EXTERNAL OPENING CONTROL

(71) Applicant: AKWEL VIGO SPAIN SL, VIGO PONTEVEDRA (ES)

(72) Inventors: Delmiro Javier COUTO MAQUIEIRA, Pontevedra (ES); José Oscar VAZQUEZ CARBALLO, Vigo (ES); Julio GARCIA RODRIGUEZ, Pontevedra (ES)

(73) Assignee: AKWEL VIGO SPAIN SL, VIGO PONTEVEDRA (ES)

(21) Appl. No.: 17/704,098

(22) Filed: Mar. 25, 2022

(30) Foreign Application Priority Data
Mar. 25, 2021 (FR) 2103002

(51) Int. Cl. E05B 85/10; E05B 83/36; E05B 81/76; E05B 81/04; B60R 13/04

(52) U.S. Cl. CPC E05B 85/103; E05B 83/36; E05B 81/76; E05B 81/04; B60R 13/04

(57) ABSTRACT

A control is configured for being integrated and concealed in a pillar of a window of the door, and includes a base secured to the pillar, trim configured for externally cladding the opening control on the pillar and supported by the base, and a control interface for electrical actuation of a lock of the door. The trim of the pillar is conformed to follow the external shape of the pillar.

The present invention relates to an external opening control for a door of an automobile. More particularly, this invention relates to an external opening control of a side door of an automobile, which may indifferently be a front door or a rear door, a control that is integrated and concealed in a pillar, for example a pillar of the bodywork of the vehicle delimiting a side window or a rear pillar of a rear-quarter panel, adjacent to the door in question.

The side doors of automobiles are generally equipped with an opening control a visible part of which is a handle, usually referred to as a gripping pallet, having a general form comparable to that of a refrigerator door handle. Such handles in general form significant protrusions on the sides of the bodywork of the vehicle or, even if they are more or less embedded in the door panel, they remain very visible.

A current trend, in the design of automobiles, is to make the controls discreet, by attempting to hide them. In particular, with regard to the external opening controls of doors, it has already been proposed to conceal these controls by integrating them in the frame of the door, by providing a handle of the pallet type flush with a pillar located at the rear of the window of the door in question. One example of an external opening control of a door of this type can be found in the French patent application FR 3034713A1.

However, such an external opening control cannot be completely concealed on the pillar, since the pallet necessarily includes a large central cutout provided for introducing the hand and for manipulating this pallet. Thus, there remains, with regard to the installation of the opening control on the pillar, lines delimiting the various members making up the opening control that impair the overall perception of the whole by an observer.

The aim of the invention is in particular to provide an external opening control remedying these aforementioned drawbacks of the prior art.

For this purpose, the object of the invention is in particular an external opening control for a door of an automobile configured for being integrated in and concealed in a pillar of a window of a door, said control comprising a base configured for being attached to the pillar, trim configured for externally cladding the opening control on the pillar and supported by the base and a control interface for electrical actuation of a lock of the door, characterized in that the trim on the pillar is conformed so as to match the external shape of the pillar and in that the base and the trim are integrally joined to form one piece that delimits a concave recess provided with a manual access opening turned to a lateral side of the door, said concave recess comprising a front wall with respect to which the control interface is arranged so as to control the electrical actuation of the lock of the door when there is manual traction on the door through the front wall of the recess,

The external opening control does not at rest have any protrusion or interruption with respect to the profile of the bodywork at the pillar. The trim is perfectly integrated on the pillar, which makes it possible to ensure an aesthetic and aerodynamic finish for the vehicle.

Moreover, the actuation of the control is particularly ergonomic since the control interface is arranged on the front wall of the piece formed by the trim and the base which makes it possible to exert a traction on the door towards its opening while actuating the unlocking and detachment of the door.

An opening control according to the invention may furthermore include one of the following features.

In a preferred embodiment of the invention, the control comprises a gripping pallet housed in the recess and configured to internally clad the concave recess starting substantially from the opening of the recess and to allow the interaction of the user with the control interface when gripping the pallet.

In a preferred embodiment of the invention, the pallet is provided with a body delimiting a concave interior cladding surface of the recess, with its concavity turned towards the opening.

In a preferred embodiment of the invention, the pallet is mounted so as to pivot inside the concave recess between an idle position wherein the control interface extends, in a non-active state, inside an intermediate space formed between the pallet and the front wall and a position of the pallet tilted towards said front wall wherein the control interface is in an active state of controlling the electrical actuation of the lock by bringing together the front wall and the pallet leading to the application of a contact pressure on the interface.

In a preferred embodiment of the invention, applying said action of manual traction on the door in the direction of the front wall of the recess causes the tilting from the idle position to the active position of the pallet.

In a preferred embodiment of the invention, the pallet is mounted integrated fixedly in the concave recess and the control interface is arranged inside a gripping space of the pallet in a zone of the pallet extending in line with the front wall of the recess.

In a preferred embodiment of the invention, the control interface is arranged adjacent and recessed with respect to an edge of the opening of the recess.

In a preferred embodiment of the invention, the control interface can be activated by contact pressure of a finger and comprises a switch of the push button type or of the type with a touch surface.

In a preferred embodiment of the invention, the trim comprises a decorative external face covered with a cladding of the mat or glossy adhesive type.

In a preferred embodiment of the invention, the base comprises a window-guide piece and the trim is configured to at least partially cover this piece.

In a preferred embodiment of the invention, the trim comprises a lateral edge designed to be mounted close to a glazed panel of the door having a non-rectilinear contour.

Another object of the invention is an automobile door comprising an external opening control characterized in that the opening control is an opening control according to the invention integrated in and concealed in a pillar of a window panel of the door.

Finally, an object of the invention is an automobile comprising a door according to the invention, wherein the opening control is accessible to gripping through a cavity provided in a wall of the vehicle that is adjacent to the pillar of the door, such as a wall of a rear-quarter panel.

Other features and advantages of the invention will emerge in the light of the following description, made with reference to the accompanying drawings, wherein:

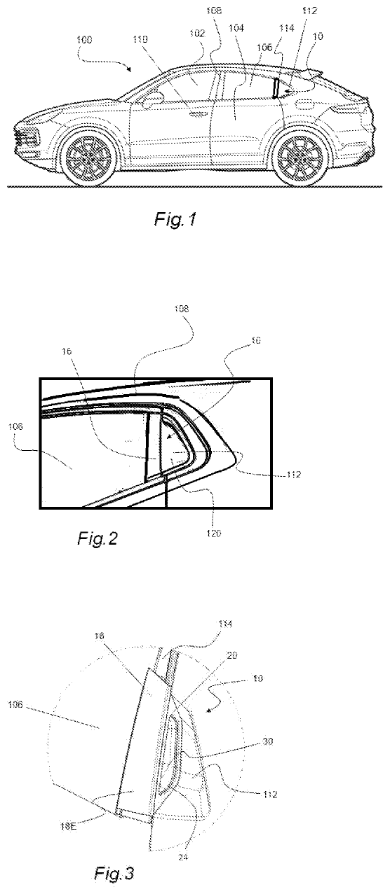

FIG. 1 shows a perspective view of an automobile comprising an external opening control according to a first embodiment of the invention mounted. on a rear pillar of a door of the vehicle;

FIG. 2 shows a partial view to an enlarged scale illustrating an external opening control of FIG. 1;

FIG. 3 shows a front three-quarter perspective view of the external opening control of FIG. 2;

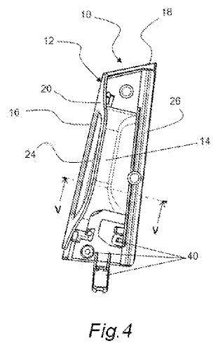

FIG. 4 shows a rear view of the opening control of FIG. 3;

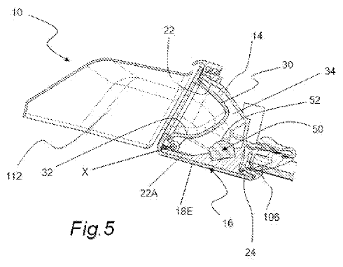

FIG. 5 shows a view in cross section of the opening control along the cutting line V-V in FIG. 4;

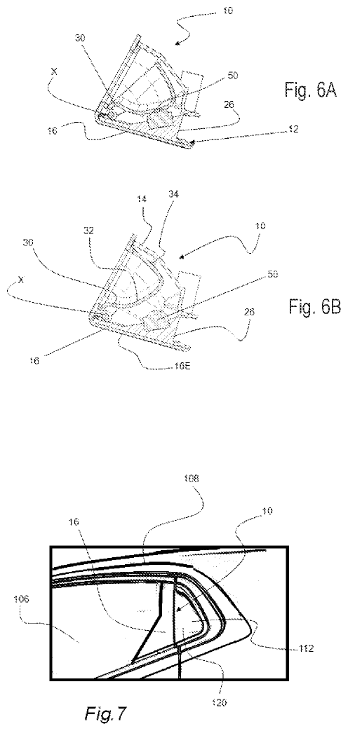

FIG. 6A shows an idle position, and FIG. 6B shows a tilted position of a gripping pallet of the opening control illustrated on FIG. 5;

FIG. 7 shows a partial view to an enlarged scale illustrating an external opening control according to a second embodiment;

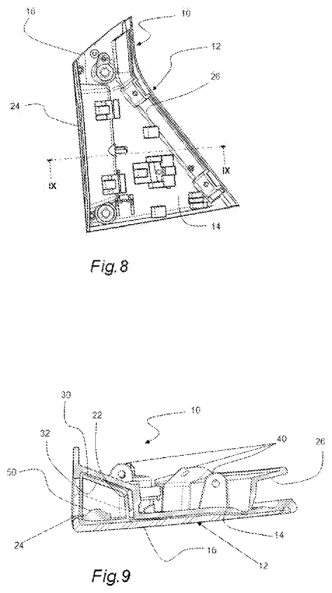

FIG. 8 shows a rear perspective view of the opening control of FIG. 7;

FIG. 9 shows a view in cross section of the opening control along the line IX-IX in FIG. 8.

FIG. 1 shows an automobile designated by the general reference 100. This vehicle 100 is a four-door vehicle, with two front side doors 102 and two rear side doors 104

These side doors 102 and 104 are all equipped with external opening controls, namely an opening control 110 for each front door 102 and an opening control 10 according to the invention for each rear door 104.

Each side door 102 or 104 comprises a door shell chiding conventionally a carrier structure that is an integral part of the bodywork of the vehicle, lined by an external door wall formed by an external metal sheet of the vehicle and referred to as a door panel.

The carrier structure of the door also comprises, in line with the door panel, a frame 108 that defines the upper contour of the door and inside which a movable or fixed glazed panel 106 generally extends. In the example illustrated, the window frame 108 is intended to frame and hold the window and comprises two lateral pillars extending vertically and able to be connected or not at their top ends by a horizontal cross-member.

On each side of the vehicle, in the example illustrated, the opening control 110 of the front door 102 is mounted on the external bodywork of the front door 102 and is in the form of a handle mounted so as to project from the door panel opposite a hollow formed in the metal sheet of this panel. The handle is in the form of a slender body externally convex so as to form, between the body and metal sheet, a passage opening for the fingers of a hand in the hollow to allow traction on the panel so as to open the door.

In accordance with the invention, the opening control 10 of the rear door 104 is located in proximity to a rear vertical pillar 114, at a vertical pillar of the frame of the window of this rear door 104.

In the example illustrated, the rear pillar 114 separates a window of the rear door 104 from a solid rear-quarter panel 112 and, in this case, the opening control 10 is located in proximity to this rear-quarter panel 112. Naturally, in a variant that is not illustrated, the vehicle may include a glazed rear-quarter panel (known according to English terminology by the expression “quarter window”).

FIGS. 1 to 6B illustrate the external opening control 10 associated with the rear door 104, in accordance with a first embodiment of the invention.

In accordance with this first embodiment of the invention, the control 10 comprises a base 14 attached along the pillar 114 and trim 16 configured for externally cladding the opening control along the pillar 114.

In particular, the trim 16 of the pillar 114 is conformed to perfectly match the external shape of the pillar 114. This conformation of the trim 16 guarantees an optimal aesthetic finish of the opening control 10 by eliminating any unaesthetic interruption on the pillar 114.

Preferably, the trim 16 has a roughly elongate shape intended to extend longitudinally and vertically along one side of the frame 108 of the glazed panel 106. The trim 16 extends, in this example, at one of its lateral borders (to the left in FIG. 2) on the window frame 106 and at the other of its lateral borders (to the right in FIG. 2) at the peripheral edge of the rear door 104.

According to the first embodiment of the invention, the base 14 and the trim 16 are integrally assembled to form one piece 12. This piece 12 delimits a concave recess 22 comprising an opening 24 extending alongside a lateral external edge of the door 104. This opening 24 allows manual access to a user for actuating the opening control 10.

The trim 16 and the base 14 can be assembled on the pillar 114 in accordance with numerous configurations and with conventional mechanical connection means 40 that will not be described further hereinafter.

Preferably, the base 14 is attached to a bodywork pillar of the door 104 and the trim 16 is mounted for example on the base 14 so as to completely cover and mask the base 14.

In the example illustrated on FIGS. 3 and 4, the trim 16 comprises a main wall 18 covering the pillar 114 and a lateral wall extension 20 conformed to surround the opening 24 of the concave recess 22.

Preferably, the trim 16 comprises, on a decorative external face 18E of its main wall 18, a cladding of the matt or glossy adhesive type, generally in a dark color such as a black color. Furthermore, this cladding can preferably be selected identical to the cladding of the solid rear-quarter panel 112.

Furthermore, preferably, the base 14 comprises, on one of its lateral edges, yet another window-guide part 26 in the general shape of a U for guiding the window 106 as it slides vertically. Preferably, the trim 16 is configured for covering this window-guide piece 26 at least partially, as can be seen on FIG. 5.

In the example illustrated, the trim 16 is located flush with the bodywork more particularly with the frame 108 of the window 106.

For example, the trim 16 comprises a lateral edge designed to be mounted alongside a glazed panel 106 of the door 104 that has a non-rectilinear contour. More generally, the contour of the trim 16 may represent a complex geometric figure, not necessarily triangular or rectangular. This has an advantage of perfectly incorporating the opening control in the rear pillar 114 of the door 108 whatever the form of the rear pillar 114 while allowing an adaptation of the form of the pillar 114 to the style of the vehicle.

According to this first embodiment, the opening control 10 comprises an interface 50 for controlling the electrical activation of a lock of the door 104.

Generally, a door 104 of an automobile, for example a rear door of the vehicle, is opened by means of a lock comprising a bolt integral with the door able to cooperate with a keeper integral with the bodywork.

In practice, the action of releasing the bolt, which enables the door to be released, is referred to as the opening of the lock; conversely, maintaining the bolt in the lock, which prevents the release of the door, is referred to as closure of the lock.

Such a lock thus makes it possible to maintain the closed position of the door of the automobile. The lock also makes it possible to release the door by action on the interior (or exterior) opening control connected to the lock and able to be actuated by a user. When the door is opened from outside the vehicle, the bolt is released from the keeper by actuation of the external opening control.

Actuation of the lock can also be done electrically by means of an electromechanical actuator (not shown on the figures) as is the case in the opening control 10 of the invention. In this case, the actuator comprises for example an electric motor, electrically supplied by the main electrical circuit of the vehicle.

In the example described, the control interface 50 enables the user to be able to issue control instructions in the direction of the electromechanical actuator. This is because, in order to increase ergonomic ease, the control interface 50 makes it possible for example to detect a contact pressure of a pressing of a finger of a user and to trigger a command intended for the electromechanical actuator following the detection of this contact pressure. Preferably, the control interface 50 can be activated by contact pressure of a finger and preferably comprises a switch of the push button type or of the touch zone type.

In particular, said concave recess 22 comprises a front wall 22A with respect to which the control interface 50 is arranged. The control interface 50 is thus disposed in the opening control 10 so that applying an action of manual traction of the door 104 by this front wall 22A of the recess 22 causes an activation of the control interface 50 causing command of the electrical actuation of the door lock.

In the first embodiment, this manual interaction of the user with the control interface 50 is done indirectly by means of a movable gripping pallet 30 housed in the concave recess 22.

In this first embodiment, the opening control 10 comprises a maneuvering member facilitating gripping of the opening control 10 normally referred to as gripping pallet 30.

Preferably, this gripping pallet 30 is housed in the recess 22 and configured for internally covering the concave recess 22 starting from the opening 24 of the recess 22, being deployed inside the recess 22 while allowing interaction of a user with the control interface 50.

This pallet 30 is mounted so as to pivot inside the recess 22 between an idle position and a position tilted inside the recess 22 towards the front wall 22A. For example, the pallet 30 is mounted articulated about a rotation axis X extending longitudinally along one edge of the opening 24 of the recess 22, while being adjacent to the front wall 22A. The rotation axis X extends for example longitudinally, substantially in a longitudinal direction of the rear pillar 114.

In the example illustrated, the pallet 30 is provided with a body delimiting a concave surface 32 of interior cladding of the recess 22, with its concavity turned towards the opening 24. The pallet 30 has fix example the general form of a bowl, the concave internal surface 32 of which is connected substantially to a contour of the opening 24 of the recess 22, as can be seen on FIG. 5 in the idle position.

Furthermore, preferably, in the idle position, the pallet 30 and the front wall 22A delimit an intermediate space 34 inside which the control interface 50 is disposed in an inactive state. In the example illustrated, the control interface 50 is arranged on an internal face of the front wall 22A positioned on a tilting path of the pallet 30.

Preferably, with reference to FIGS. 6A and 6B, the pallet 30 is mounted so as to pivot inside the concave recess 22 between its idle position (FIG. 6B), in which the control interface 50 is in an active state, and its active position tilted towards the front wall 22A (FIG. 6A), producing the application of a contact pressure on the control interface 50 by moving the pallet 30 towards the front wall 22A.

Applying an action of manual traction of the door by the front wall 22A of the recess 22 thus causes, very intuitively for the user, the tilting from the idle position to the active position of the pallet 30, causing the electrical actuation of the lock, enabling the door 104 to be opened.

In order to limit the travel of the pivoting path of the pallet 30 inside the recess 22, the front wall 22A of the recess 22 has a relief on its internal face on which the control interface 50 is arranged. This relief is configured for making it possible to reduce the angular amplitude of pivoting of the pallet 30 inside the recess 22. For example, the internal face of the front wall 22A by bending of the internal face 22A. This makes it possible to reduce the angular amplitude of pivoting of the pallet 30 inside the recess 22, which optimizes the ergonomics of the opening control 10.

For example, the control interface 50 comprises a switch of the push button 52 type. This switch 52 comprises, in the example illustrated, a contact portion having a roughly convex shape, for example in the form of a convex dome and defining a press-in actuation wall. Pressing in this wall triggers the switch 52.

Thus, in the example illustrated on FIG. 6A, when the pallet 30 is tilted towards the front wall 22A of the recess 22, the wall of the pallet 30 crushes or presses in the actuation wall in the form of a convex dome of the switch 52, leading to triggering thereof.

In this first embodiment, the reverse return path of the pallet 30 to the idle position after the door is opened is done for example by means of elastic means of the spring type that will not be described further.

FIGS. 7 to 9 show a second embodiment of the invention. In this second embodiment, the elements similar to those of the first embodiment bear identical references.

On FIG. 7, the trim 16 has a complex geometric shape with a non-rectilinear lateral edge, for example forming an angle. Naturally, this form is non-limitative.

On these figures, the base 14 and the trim 16 delimit together the recess 22. For example, as illustrated on FIG. 9, the base 14 delimits a dorsal wall and a lateral wall of the recess 22 and the trim 16 delimits a front wall 22A of the recess 22. The base 14 and the trim 16 are next extended adjacently beyond the recess 22 in the transverse direction of the pillar 114.

In this example, the gripping pallet 30 is fixed with respect to the piece 12 and is completely embedded inside the recess 22 by complementarity of shape.

Preferably, the pallet 30 is mounted so as to be integrated fixedly in the concave recess 22 and the control interface 50 is arranged inside a gripping space of the pallet 30 in a zone of the pallet 30 extending in line with the front wall 22A of the recess 22.

Preferably, in this second embodiment, the control interface 50 is arranged so as to be adjacent and recessed with respect to an edge of the opening 24 of the recess 22. In this second embodiment, the control interface 50 extends inside a gripping space of the pallet 30, for example in a region of the cladding surface of the pallet 30 extending in line with the front wall 22A of the recess 22. In this second embodiment, the user acts directly on the control interface 50.

For example, as in the first embodiment, the control interface 50 comprises a switch of the push button type 52. This switch 52 comprises a contact portion having a roughly convex shape, for example in the form of a convex dome and defining a press-in actuation wall. Pressing in this wall triggers the switch 52.

As illustrated on FIG. 9, the push button 52 extends adjacent to the opening 24 of the recess 22 on a wall of the pallet 30 extending on the front wall 22A of the recess 22.

Preferably, in the two embodiments of the invention, the opening control 10 is accessible for gripping through a cavity 120 formed in a wall of the vehicle 100 that is adjacent to the upright 114 of the door 104. In the example illustrated, the cavity 120 is formed in the rear-quarter panel 112.

A description will now be given of the main aspects of the operation of an opening control according to the first embodiment of the invention with reference to FIGS. 1 to 6B.

The trim 16 preferably matches the shape of the rear vertical pillar 114 so that the opening control 10 is completely concealed in the pillar 114.

Initially, the pallet 12 is positioned in its idle configuration inside the concave housing 22 of the piece 12 formed by the assembly of the trim 16 and base 14.

To initiate the pivoting of the pallet 30. the user engages the fingers of one of his hands inside the follow formed by the concave recess 22. For example, this hollow is made accessible laterally for gripping by virtue of the cavity 120 formed in the rear-quarter panel 112. A user thus manages to effect manual traction on the front wall 22A of the recess 22 by engaging the pivoting of the pallet 30 inside the recess 22 as far as the front wall 22A.

This movement leads to the pivoting of the pallet 30 to a position of maximum pivoting inside the recess 22. At the end of movement of the pallet 30, the pallet 30 acts on the control interface 50, which causes the electrical actuation command on the lock, enabling the door 104 to be opened.

When the pallet 30 is released, it returns to the initial idle position, under the effect of the various return means provided, which will not be detailed further.

The invention is not limited to the embodiments previously described. Other embodiments within the capability of a person skilled in the art can also be envisaged without departing from the scope of the invention defined by the following claims.

1. The external opening control for a door of an automobile configured for being integrated in and concealed in a pillar of a window of the door, said control comprising a base configured for being attached to the pillar, a trim configured for externally cladding the opening control on the pillar and supported by the base and a control interface for electrical actuation of a lock of the door, wherein the trim on the pillar is conformed so as to match the external shape of the pillar and in that the base and the trim are integrally joined to form one piece that delimits a concave recess provided with a manual access opening turned to a lateral side of the door, said concave recess comprising a front wall with respect to which the control interface is arranged so as to control the electrical actuation of the lock of the door when there is manual traction on the door through the front wall of the recess.

2. The control according to claim 1, comprising a gripping pallet housed in the recess and configured to internally clad the concave recess starting substantially from the opening of the recess and to allow the interaction of the user with the control interface when gripping the pallet.

3. The control according to claim 1, wherein the pallet is provided with a body delimiting a concave interior cladding surface of the recess, with its concavity turned towards the opening.

4. The control according to claim 2, wherein the pallet is mounted so as to pivot inside the concave recess between an idle position wherein the control interface extends, in a non-active state, inside an intermediate space formed between the pallet and the front wall and a position of the pallet tilted towards said front wall wherein the control interface is in an active state of controlling the electrical actuation of the lock by bringing together the front wall and the pallet leading to the application of a contact pressure on the interface.

5. The control according to claim 4, wherein applying said action of manual traction on the door in the direction of the front wall of the recess causes the tilting from the idle position to the active position of the pallet.

6. The control according to claim 2, wherein the pallet is mounted integrated fixedly in the concave recess and the control interface is arranged inside a gripping space of the pallet in a zone of the pallet extending in line with the front wall of the recess.

7. The control according to claim 6, wherein the control interface is arranged adjacent and recessed with respect to an edge of the opening of the recess.

8. The control according to claim 1, wherein the control interface can be activated by contact pressure of a finger and comprises a switch of the push button type or of the type with a touch surface.

9. The control according to claim 1, wherein the trim comprises a decorative external face covered with a cladding of the mat or glossy adhesive type.

10. The control according to claim 1, wherein the base comprises a window-guide piece and the trim is configured to at least partially cover this piece.

11. The control according to claim 1, wherein the trim comprises a lateral edge designed to be mounted close to a glazed panel of the door having a non-rectilinear contour.

12. The automobile door comprising an external opening control, wherein the opening control is an opening control according to claim 1 integrated in and concealed in a pillar of a window panel of the door.

13. The automobile comprising a door according to claim 12, wherein the opening control is accessible to gripping through a cavity provided in a wall of the vehicle that is adjacent to the pillar of the door, such as a wall of a rear-quarter panel.
